(19) United States
(12) Patent Application Publication
(10) Pub. No.: US 2006/0176902 A1
(43) Pub. Date: Aug. 10, 2006

(54) Method of processing a multimedia message, a storage medium, and an associated processing system

(75) Inventors: Philippe Bellordre, Paris (FR); Aline Potier, Antony (FR)

Correspondence Address: YOUNG & THOMPSON, 745 SOUTH 23RD STREET, 2ND FLOOR, ARLINGTON, VA, 22202, US

(73) Assignee: FRANCE TELECOM, PARIS (FR)

(21) Appl. No.: 11/050,707

(22) Filed: Feb. 7, 2005

(30) Foreign Application Priority Data
Feb. 5, 2005 (FR) 04290303.9

(51) Int. Cl. H04J 3/16

(52) U.S. Cl. 370/466

(57) ABSTRACT

The invention relates to a method of processing a multimedia message sent by a telecommunications terminal of one party to a telecommunications terminal of a recipient, said message containing at least one identification element for the terminal and at least one audio or video multimedia object. The method comprises the following steps: extracting said multimedia message from said audio or video object; storing said object in multimedia object storage means; creating a location address of the storage location of said audio or video object in said multimedia object storage means; and inserting said location address in the multimedia message instead of said audio or video object to constitute a substitute multimedia message. The invention also relates to a multimedia message processing system.

The invention relates to a method of processing a multimedia message and a corresponding processing system.

### BACKGROUND OF THE INVENTION

Streaming is a technology for transferring data in the form of a regular and continuous stream. It is used to broadcast audio or video multimedia objects over a fixed cable or other network and/or over a mobile network in real time. To use this technology in a mobile network, a user in possession of a telecommunications terminal including a streaming client module may log onto a WAP site, choose a video stored in a streaming server, and request that the video concerned be sent to the terminal in a streaming mode.

However, the above technology does not allow a user to receiver contextual information such as a picture or text, for example, at the same time as the audio or video object.

A multimedia messaging service (MMS) enables users to send and receive multimedia messages on a mobile telecommunications terminal incorporating an MMS client module. Multimedia messages contain text objects and/or picture objects and/or sound objects and/or video objects. The multimedia messaging service may be deployed on a mobile network, for example a GSM, GPRS or UMTS network, or on a fixed cable or other network. Multimedia messages received by a telecommunications terminal are stored in its memory. They are then viewed on a display-player at the request of the user.

However, because telecommunications terminals have limited memory capacity, it is not possible to send large multimedia messages to them.

### OBJECTS AND SUMMARY OF THE INVENTION

An object of the invention is to enable telecommunications terminals to facilitate the exchange of large multimedia messages.

To this end, the invention provides a method of processing a multimedia message, the method comprising the following steps:

extracting said multimedia message from said audio or video object;

storing said object in multimedia object storage means;

creating a location address of the storage location of said audio or video object in said multimedia object storage means; and

inserting said location address in the multimedia message instead of said audio or video object to constitute a substitute multimedia message.

Particular embodiments of the method of the invention have one or more of the following features:

the method further comprises a preliminary step of searching the information storage means for information authorizing processing of said message using the identification element of the terminal receiving the message (terminal of the recipient), said authorization information defining if the terminal receiving the message subscribes to the processing method;

the method further comprises the following steps:
extracting from said audio or video object a sequence representative of the audio or video object; and
inserting said sequence into the substitute multimedia message that has been constructed;

the step of storing the audio or video object is preceded by a step of processing the object comprising the following steps:
searching the information storage means for information defining the technical features of the terminal receiving the message; and
modifying said audio or video object to adapt it to the technical features of the terminal receiving the message;

the method further comprises the following steps:
searching the multimedia message for each audio or video object; and
sending the multimedia message to the terminal receiving the message if there is no audio or video object in the multimedia message;

the method comprises the following steps:
generating a code describing the content of the substitute multimedia message; and
replacing the description code of the multimedia message by the description code of the substitute multimedia message.

The invention also provides a system for processing a multimedia message, the system comprising:

add/extraction means adapted to extract each audio or video object in said multimedia message;

means for substituting a location address of the storage location of each audio or video object, the substitution means comprising:
means for storing multimedia objects adapted to store each audio or video object; and
means for creating a location address of the storage location of each audio or video object in the storage means;
said add/extraction means inserting said location address in the multimedia message instead of said audio or video object to generate a substitute message.

Particular embodiments of the processing system comprise one or more of the following features:

the substitution means are in a streaming server and the add/extraction means are in a processing application server; and

the add/extraction means and the substitution means are in a processing application server.

The invention further provides a storage medium containing a computer program including instructions for executing steps of the method of processing a multimedia message when the program is executed on a computer.

### BRIEF DESCRIPTION OF THE DRAWINGS

The invention will be better understood on reading the following description, which is given by way of example only and with reference to the accompanying drawings, in which:

FIG. 1 is a functional block diagram of one example of a system in accordance with the invention for processing a multimedia message;

FIG. 2 is a diagram of the steps of a method of the invention of processing a multimedia message;

FIG. 3 is a block diagram of one example of a prior art multimedia message; and

FIG. 4 is a block diagram of processing by the method of the invention of the multimedia message represented in FIG. 3.

### MORE DETAILED DESCRIPTION

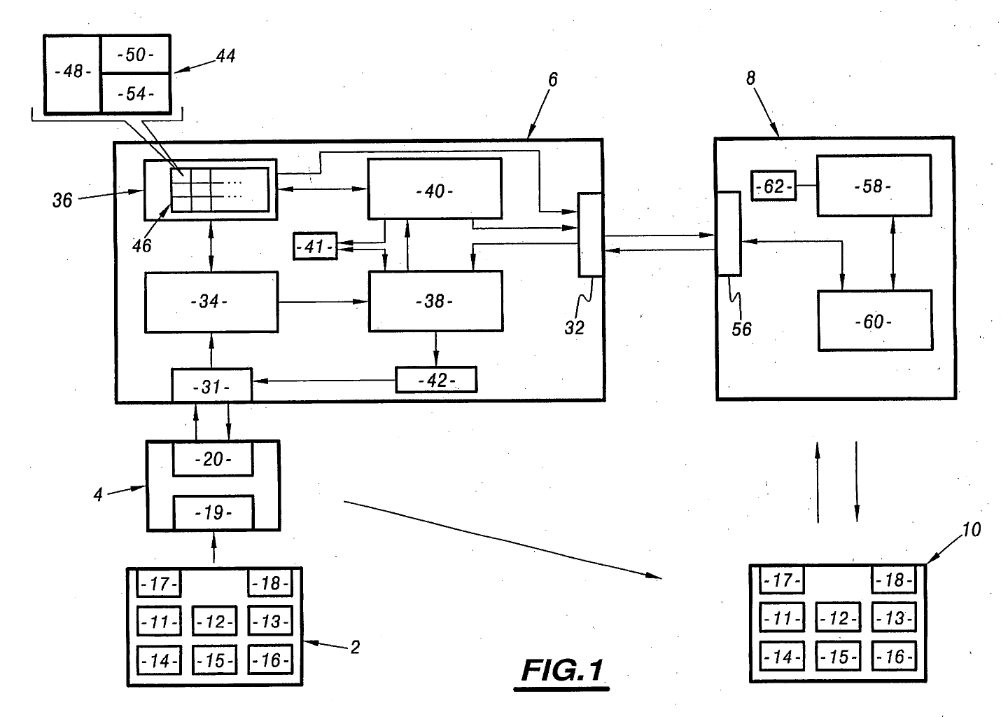

FIG. 1 is a diagram of one example of a system of the invention for processing a multimedia message. In this example, the party sending a multimedia message and the recipient of the message are subscribers of the same operator.

The message processing system comprises a telecommunications terminal 2 of a party sending a multimedia message, a multimedia message server 4, an application server 6, a streaming server 8, and a telecommunications terminal 10 of the recipient of the multimedia message sent by the terminal 2.

The communications terminals 2 and 10 are known in the art and are not described in detail. They include a multimedia client module 11, an SMIL editor 12, a memory 13, a man/machine interface 14, operators 15 for processing multimedia objects, a streaming client module 16, an interface 17 with the multimedia message server 4, for example an MM1 interface, and an interface 18 for communicating with a packet-switched network usually called the Internet.

The multimedia message server 4 is known in the art and is not described in detail. It includes an interface 19 for communicating with the mobile terminals 2 and 10, for example an MM1 interface, and an interface 20 for communicating with the application server 6, for example an MM7 interface.

According to the invention, the multimedia server 4 sends multimedia messages from the terminals 2 of the calling parties to the application server 6 and sends substitute multimedia messages from the application server 6 to the telecommunications terminals 10 of the recipients, subject to certain conditions.

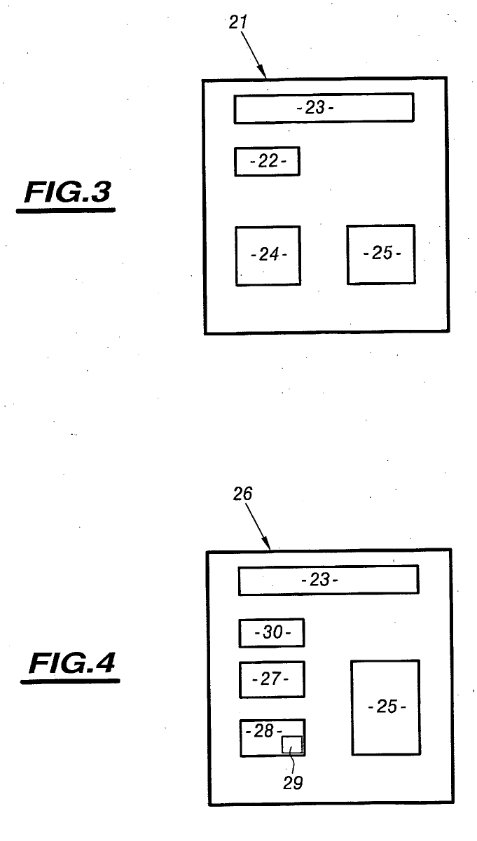

FIG. 3 represents one example of a multimedia message 21, which comprises an SMIL description code 22 describing the content of the message 21, an identification element 23 identifying the terminal 10 receiving the message, such as its telephone number, an audio or video object 24, a text object 25, and one or more picture objects.

FIG. 4 represents one example of a substitute multimedia message 26 generated by the message processing system of the invention from the message 21 represented in FIG. 3. This substitute message 26 comprises the identification element 23, the text object 25 and/or the picture objects, a sequence 27, and an SDP definition file 28 replacing the audio or video object 24, as well as a new SMIL description code 30 describing the content of the substitute message.

The sequence 27 is an object comprising one or more representative extracts from the audio or video object. For example, it contains one or more pictures from a video (animated GIF) or a musical excerpt.

The SDP definition file 28 relates to the audio or video object and to its storage location. It includes a URL hyperlink address 29 of the storage location of the object. The definition file 28 appears in the substitute message 60 only in the form of the hyperlink 29. The other information in the SDP file 28 is not visible to the recipient.

The application server 6 comprises an interface 31 for communicating with the multimedia server 4, for example an MM7 interface, an interface 32 for communicating with the streaming server 8 and using the SOAP and XML communications protocols, for example, a verification front-end 34, data storage means 36, an add/extraction module 38, an audiovisual processing module 40, a temporary storage memory 41, and an SMIL editor 42.

The verification front-end 34 receives the multimedia message 21 sent by the server 4 and searches the message 21 for an audio or video multimedia object.

If the multimedia message 21 does not contain an audio or video object, the verification front-end 34 sends the message to the server 4 via the interfaces 20 and 31.

If the message 21 contains an audio or video object 24, the verification front-end 34 searches the storage means 36 for information 50 authorizing use of the method of the invention to process the multimedia message. Authorization is granted to any recipient who has subscribed to a message processing service conforming to the invention.

If the user has subscribed to this service, the verification front-end 34 communicates the multimedia message 21 to the add/extraction module 38.

The data storage means 36 comprise a database 46 in which information files 44 are stored for each recipient who has subscribed to the service provided by the multimedia server 4. Each file 44 contains information 48 identifying the terminal 10 of the recipient, for example its telephone number or its MSISDN, subscription information 50, and technical information 54 relating to the recipient's terminal 10.

The subscription information 50 indicates if processing of the message by the method of the invention is authorized or not. Authorization is granted to any terminal user who subscribes to the processing service of the invention.

The technical information 54 is used to adapt the format, sound and size of the audio and video objects to the technical features of the destination terminal.

The add/extraction module 38 or add/drop module extracts the audio or video object 24 contained in the message 21. It also sends the message minus audio or video objects to the temporary storage memory 41 and communicates each extracted audio or video object to the audiovisual processing module 40.

The add/extraction module 38 constructs a substitute message 26. It searches the memory 41 for the sequence 27 and the message 21 using the element 23 identifying the recipient's terminal and creates a substitute message 26 from the message 21 using the identification element 23 and multimedia objects 25 of a type other than audio or video objects and substituting the definition file 28 sent by the server 8 for the audio or video object 24.

It also inserts the sequence 27 from the memory 41 into the new message created.

The audiovisual processing module 40 searches the storage means 36 for the technical features 54 of the terminal 10 and modifies audio and video objects contained in the message 21 to adapt them to the technical features of the terminal 10.

Processing a video object entails the format of its sequence, modifying its size (number of pixels) to adapt it to the size of the screen of the terminal 10, or reducing its size (number of bytes) to take account of the object reception characteristics, for example. The module 40 sends the processed audio or video object to the streaming server 8.

The processing module 40 also analyses the video or audio object in order to extract from it a sequence 27 representative of it. In the case of a video object, a representative image might be the first image of the video or the most meaningful image of the video. In which case, the processing module analyses all of the video and deduces the most representative image, which is coded in a picture format such as the JPEG format, for example.

The storage means 41 store the multimedia message 21 minus the audio or video objects and the sequence 27 generated by the module 40. These elements are stored in such a way that the identification element 23 of the terminal 10 of the recipient of the message may be used as their address.

The Synchronized Multimedia Integration Language (SMIL) editor 42 generates an SMIL descriptive file 30 describing the content of the substitute multimedia message and replaces the SMIL descriptive file 22 describing the content of the existing message before processing by the new SMIL descriptive file 30.

The editor 42 generates an SMIL code for each multimedia object contained in a message in markup tag to synchronize the multimedia objects between themselves. A description of the Synchronized Multimedia Integration Language is available at the following address: “Synchronized Multimedia Integration Language (SMIL) Boston specification”, W3C, working draft SMIL 2.0 07 August 2001 URL: http://www.w3c.org/TR/smi120/.

However, a different language could be used.

The streaming server 8 comprises a communications interface 56 using the SOAP or XML protocol, for example, a memory 58 for storing audio and video objects, means 60 for generating an SDP definition file 38, and a decoder 62.

The storage means 58 store the audio or video objects 24 at a location address.

The means 60 for generating an SDP definition file 28 generate a definition file relating to the audio or video object 24 coded in accordance with an SDP protocol.

The file 28 contains at least one hyperlink address 29 of the location in the memory 58 of the audio or video object 24 sent by the application server for example a rtps=// . . . type hyperlink address. The file 28 may also contain information on the audio or video object 24, for example its format, or information on connection to the streaming server 8.

The connection information includes in particular the identification of the session and its creator, the version of the protocol to use for the connection, the session name, a description of the hyperlink URI, an electronic address, the media name and transport address, bandwidth information, and line attributes.

The generation means 60 send the generated SDP definition file 28 to the application server 6.

The decoder 62 decodes and decompresses audio and video objects stored in the memory 58 before they are streamed to the terminal 10.

The MMS client module 10, the communications interfaces 17, 18, 31, 32, 56, the verification front-end 34, the add/extraction module 38, the audiovisual processing module 40, the SMIL editor 42, the generation means 60, and the decoder 62 may be implemented in the form of hardware on a microcontroller or in the form of software on a software medium or a programmed component in non-volatile memory executed by a microprocessor.

In an alternative embodiment of the invention the data storage means 36 may be in an independent storage server. In this case, the audiovisual processing module 40, the verification front-end 34, and the generation means 60 interrogate this server via the communications interface 32.

Alternatively, the files 44 of each recipient contain only identification information 48 and subscription information 50. In this case, another server stores the technical information 54 concerning the recipients' terminals in a database that is interrogated by the processing module 40.

In a variant of the invention, the application server 6 comprises means 58 for storing audio and video objects 24, means for generating an SDP definition file, and a decoder 62. In this case, the application server 6 stores the audio and video objects and generates only the SDP definition file 28, with no intervention by a streaming server 8.

If the calling party and the recipient of the message are not subscribers to the same operator, the multimedia message 22 is sent to the multimedia server of the calling party, which transfers it to the multimedia server 4 of the operator of the recipient of the message for processing by the method of the invention described hereinabove.

The multimedia messages 21 generated by a content server may be processed by the processing system of the invention.

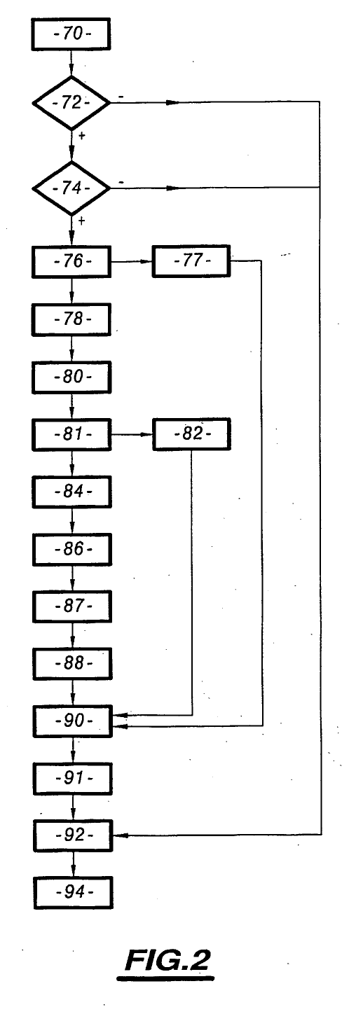

FIG. 2 shows the method of the invention of processing a multimedia message.

During a step 70 of the processing method of the invention, the multimedia message server 4 sends the application server 6 a multimedia message 21.

For example, the multimedia message 21 is sent to the electronic address: MSIDSN@streaming.com, in which “MSIDSN” is the identification element 23 and corresponds to the telephone number of the terminal 10 and “streaming.com” is the address of the application server 6.

During a step 72, the verification front-end 34 analyses the message 21 and looks in the message for an object to be sent in streaming mode, such as an audio or video object 24.

During a step 92, if the message does not contain any such object, the verification front-end 34 sends the multimedia message 21 to the multimedia server 4.

On the other hand, if the message does contain an object of this kind, and if the terminal 10 receiving the message does subscribe to the processing service of the invention, the verification front-end 34 looks in the database 36 for the recipient during a step 74.

To this end, it searches the database 44 for an identification element 48 corresponding to the identification element 23 contained in the message 21 and then for information 50 on the subscription to the method according to the invention of processing the message 21.

During the step 92, if the recipient using the terminal 10 does not subscribe to the service, the multimedia message 21 is sent to the multimedia server 4.

On the other hand, if the recipient using the terminal 10 is authorized to use the processing method of the invention, the front-end 34 sends the message 21 to the add/extraction module 38.

During a step 76, the add/extraction module 38 extracts each audio or video object 24 and sends each extracted audio or video object to the processing module 40.

During a step 77, the add/extraction module 38 stores the message 21 minus audio or video objects in the temporary storage means 41 so that it may be retrieved using the identification element 23 of the terminal 10 receiving the message.

During a step 78, the processing module 40 searches the database 44 of the storage means 36 for the technical information 54 concerning the terminal receiving the message in order to adapt the audio or video object to the technical features of the terminal.

During a step 80, the processing module 40 determines from the technical information 54 whether the audio or video objects 24 must be adapted to the terminal 10 receiving the message. It then modifies them to adapt them to the terminal 10 if necessary.

During a step 81, the processing module 40 analyses each audio or video object 24 and extracts from it a sequence 27 representative of the audio or video object.

During a step 82, each sequence 27 is stored in the temporary storage means 41 at the same address as the message 21 minus the audio or video objects 24.

During a step 84, the processing module 40 sends the streaming server each audio or video object 24 processed during the step 80 via the communications interfaces 32 and 56.

During a step 86, the generation means 60 store the audio or video object 24 in the memory 58 at an identifiable storage location.

During a step 87, the generation means 60 generate an SDP definition file 28 containing the address 29 of the storage location of the audio or video object 24 and where applicable information concerning the object 24 and connection information.

During a step 88, the SDP file 28 is sent to the add/extraction module 38 of the application server 6 via the interfaces 32 and 56.

During a step 90, the add/extraction module 38 generates a new substitute multimedia message 26.

To this end, during the step 77, and using the identification element 23, it searches the temporary storage means 41 for the message 21. It creates a new substitute message 26 using the headers of the original message 21 and multimedia objects not processed by the method of the invention, for example text objects 25, without changing their position in the message. It substitutes the SDP definition file 28 sent by the server 8 for the audio or video object 24 of the original message.

It inserts the sequence 27 representative of the audio or video object extracted during the step 82 and stored in the temporary storage means 41.

The add/extraction module 38 then sends the substitute message to the SMIL editor 42.

During a step 91, the SMIL editor 42 generates a new description code 30 of all the objects contained in the substitute message 26 and in particular a sequence object 27 and an SDP definition file object 28. This SMIL description code replaces the description code 22 of the original message 21.

During a step 92, the application server 6 sends the substitute message 26 to the multimedia server 4.

Finally, in the step 94, the multimedia server 4 communicates the message to the terminal 10 receiving the message at the telephone number MISDN.

When that terminal receives the substitute message 26, the recipient may, using the man-machine interface 14, connect to the packet-switched network and use the streaming client module 16 to search the memory 58 of the streaming server 8 for the audio or video object 24.

To this end, the streaming client module 16 uses the SDP definition file inserted into the message by the processing method of the invention.

On receiving the streaming request sent by the terminal 10 receiving the message, the server 8 sends the audio or video object 24 to the terminal 10 using a downloading mode 52 selected by the application server 6. The application server chooses the downloading mode appropriate to the sampling of the audiovisual content. The conventional progressive downloading mode or the streaming mode may be used, for example. Progressive downloading consists in downloading the audio or video file or a portion of the audio or video file into a buffer memory of the terminal 10 before reading it. Streaming consists in reading the file as it is downloaded without storing it in a memory.

This method has the advantage that it avoids saturating the memory of a telecommunications terminal.

1. A method of processing a multimedia message sent by a telecommunications terminal of one party to a telecommunications terminal of a recipient, said message containing at least one identification element for the terminal and at least one audio or video multimedia object, the method comprising the following steps:
extracting said multimedia message from said audio or video object;
storing said object in multimedia object storage means;
creating a location address of the storage location of said audio or video object in said multimedia object storage means; and
inserting said location address in the multimedia message instead of said audio or video object to constitute a substitute multimedia message.

2. A method according to claim 1 of processing a multimedia message, the method further comprising a preliminary step of searching the information storage means for information authorizing processing of said message using the identification element of the terminal receiving the message, said authorization information defining if the terminal receiving the message subscribes to the processing method.

3. A method according to claim 1 of processing a multimedia message, the method further comprising the following steps:
extracting from said audio or video object a sequence representative of the audio or video object; and
inserting said sequence into the substitute multimedia message that has been constructed.

4. A method according to claim 1 of processing a multimedia message, wherein the step of storing the audio or video object is preceded by a step of processing the object, said processing step comprising the following steps:
searching the information storage means for information defining the technical features of the terminal receiving the message; and
modifying said audio or video object to adapt it to the technical features of the terminal receiving the message.

5. A method according to claim 1 of processing a multimedia message, the method further comprising the following preliminary steps:
searching the multimedia message for each audio or video object; and
sending the multimedia message to the terminal receiving the message if there is no audio or video object in the multimedia message.

6. A method according to claim 1 of processing a multimedia message further comprising a code describing its content, the method comprising the following steps:
generating a code describing the content of the substitute multimedia message; and
replacing the description code of the multimedia message by the description code of the substitute multimedia message.

7. A system for processing a multimedia message to be sent by a telecommunications terminal of one party to a telecommunications terminal of a recipient and containing at least one identification element of the terminal receiving the message and at least one audio or video object, the processing system comprising:
add/extraction means adapted to extract each audio or video object from said multimedia message;
means for substituting a location address of the storage location of the audio or video object for each audio or video object, the substitution means comprising:
means for storing multimedia objects adapted to store each audio or video object; and
means for creating a location address of the storage location of each audio or video object in the storage means;
said add/extraction means inserting said location address in the multimedia message instead of said audio or video object to generate a substitute message.

8. A system according to claim 7 of processing a multimedia message, wherein the substitution means are in a streaming server and the add/extraction means are in a processing application server.

9. A system according to claim 7 of processing a multimedia message, wherein the add/extraction means and the substitution means are in a processing application server.

10. A storage medium containing a computer program including instructions for executing steps of the method according to claim 1 of processing a multimedia message when the program is executed on a computer.
